(19) United States
(12) Patent Application Publication
(10) Pub. No.: US 2008/0145673 A1
(43) Pub. Date: Jun. 19, 2008

(54) FLEXIBLE SUBSTRATES COATED WITH FLEXIBLE STAIN RESISTANT COATINGS AND METHODS OF MANUFACTURE AND OF USE THEREOF

(76) Inventor: Fabienne BONNARD, Shawinigan-Sud (CA)

Correspondence Address: GOUDREAU GAGE DUBUC, 2000 MCGILL COLLEGE, SUITE 2200, MONTREAL, QC, H3A 3H3, omitted

(21) Appl. No.: 11/610,227

(22) Filed: Dec. 13, 2006

(51) Int. Cl. B32B 27/06; B32B 17/10; C08F 2/46; C08F 2/00

(52) U.S. Cl. 428/430; 428/483; 428/480; 427/487; 525/418

(57) ABSTRACT

A coated flexible substrate comprising: a flexible substrate, and a coating disposed on at least a portion of said substrate, wherein said coating is manufactured by radiation curing a liquid coating composition comprising at least one polyester acrylate-based oligomer having between 2 and 4 acrylate functionalities and at least one acrylate monomer. A method of coating a flexible substrate comprising the step of: disposing a coating composition comprising at least one acrylic monomer and a polyester acrylate-based oligomer having between 2 and 4 acrylate functionalities on at least one portion of said flexible substrate; and radiation curing said composition.

### CROSS REFERENCE TO RELATED APPLICATIONS

N/A.

### FIELD OF THE INVENTION

The present invention relates to flexible substrates coated with flexible stain resistant coatings and methods of manufacture and of use thereof. More specifically, the present invention relates to polyester acrylate-based radiation curable coatings.

### BACKGROUND OF THE INVENTION

Traditional curable coatings for flooring substrates or laminates for use on counters or cupboards are polyurethane acrylates-based. These coatings however do not generally display simultaneously a high stain resistance and flexibility. Flexibility in a coating may be desirable when the coating is to be applied on a substrate that is three dimensional (i.e. not perfectly plane) or meant to cover a three dimensional surface (e.g. curved counters, cupboards with relief, etc.) or a substrate that will be rolled or otherwise folded prior to its application on a surface (e.g. pre-coated substrates shipped and/or sold in rolls, etc.). Furthermore polyurethane acrylates-based coatings often disadvantageously dry more slowly and are thus more costly to dry.

The present invention seeks to meet these and other needs.

The present description refers to a number of documents, the content of which is herein incorporated by reference in their entirety.

### SUMMARY OF THE INVENTION

The present invention relates to a coated flexible substrate comprising: a flexible substrate, and a coating disposed on at least a portion of said substrate, wherein said coating is manufactured by radiation curing a liquid coating composition comprising at least one polyester acrylate-based oligomer having between 2 and 4 acrylate functionalities and at least one acrylate monomer. The substrate may be a flooring substrate. More particularly, it may be vinyl.

The oligomer has between 2 to 4 acrylate functionalities. Typically, it will thus have 2 acrylate functionalities, 2.5 acrylate functionalities, 3 acrylate functionalities, 3.5 acrylate functionalities or 4 acrylate functionalities.

The coating may comprise between about 20.0% and about 50.0% wiw of the oligomer. The coating may comprise between about 20.0% and about 50.0% w/w of the monomer.

The monomer may be mono-functional, bifunctional or tri-functional. The monomer may be a neopentyl glycol propoxylate diacrylate.

The coating may further comprise a photoinitiator. The coating may comprise between about 3.0% to about 7.0% w/w of the photoinitiator.

The coating may further comprise at least one type of particles. The coating may comprise between about 5.0% and about 35.0% w/w of particles. The particles may be selected from the group consisting of texturing particle, matting particle, scratch-resistant particles and combinations thereof. The matting particle may be silica. The scratch-resistant particle may be a ceramic. The texturing particle may be a polypropylene wax.

The coating may further comprise at least one additive. The additive may be in a concentration of about 1.0% to about 5% w/w of the composition, more preferably about 1.0% to about 4% w/w of the composition. The additive may be selected from an anti-foaming agent, a dispersant, a stabilizer, a leveling agent and mixtures thereof.

The present invention also relates to a method of coating a flexible substrate comprising the step of disposing a coating composition comprising at least one acrylate monomer and a polyester acrylate-based oligomer having between 2 and 4 acrylate functionalities on at least one portion of said flexible substrate; and radiation curing said composition.

In the method of the invention, the coating may be as defined above.

In the method of the invention, the substrate may be a flooring substrate. The substrate may be vinyl.

The coating may be between about 10 and about 30 microns thick after curing.

The coating may be cured at an energy between about 250 and about 2000 mJ. Alternatively, the coating may first be cured at an energy between about 70 and about 150 mJ under oxygen atmosphere and may then be cured at an energy between about 750 and about 1300 mJ under an inert atmosphere.

The present invention also relates to a coating composition for coating a flexible substrate. This composition comprises a polyester acrylate-based oligomer having between 2 and 4 acrylate functionalities and at least one acrylate monomer.

### BRIEF DESCRIPTION OF THE DRAWINGS

In the appended drawings:

FIG. 1 is a graph comparing stain-resistance (De) of polyurethane-based coatings with that of polyester-based coatings having a ¼ flexibility after staining agent # 1 was applied for 1 hour. De represent the color difference between the stain and unstained coated substrate. A larger De means a larger color difference, i.e. a more apparent stain.

FIG. 2 is a graph comparing stain-resistance of polyurethane-based coatings with that of polyester-based coatings having a ¼ to ½ flexibility after staining agent # 1 was applied for 1 hour;

FIG. 3 is a graph comparing stain-resistance of polyurethane-based coatings with that of polyester-based coatings having a ¼ flexibility after staining agent # 1 was applied for 24 hours; and

FIG. 4 is a graph comparing stain-resistance of polyurethane-based coatings with that of polyester-based coatings having a ¼ to ½ flexibility after staining agent # 1 was applied for 24 hours.

### DESCRIPTION OF ILLUSTRATIVE EMBODIMENTS

The applicants are the first to demonstrate the unexpected usefulness of multifunctional polyester acrylates in radiation curable coatings in terms of stain-resistance and flexibility. In fact, it has been surprisingly found that polyester acrylate oligomers can advantageously be used in radiation curable coatings to coat flexible substrates.

Polyester acrylates oligomers are well known by the person of skill in the art of curable coatings and resins. A great number of these oligomers are available commercially. Although their exact chemical formulas are not disclosed to the public (trade-secrets), several of their characteristics are well known.

First, these oligomers comprise acrylate and ester functionalities. These functionalities usually have the following formulas:

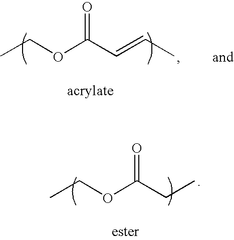

These oligomers are low-to-medium weight polymers; i.e. they have a molecular weight between about 500 and about 5000 g/mol. They are usually described using the number of acrylate functionalities that they contain. They can be for example, mono-, bi-, tri-, tetra-, hexa-functional, etc. The number of functionalities may also be a non-integer number, such as 2.5 or 3.5. This is an average of the functionalities of the oligomer. For example, when the oligomer may vary from 2 to 3 functionalities, the number of functionalities will be identified as 2.5.

In the present invention, it has surprisingly been found that polyester acrylates oligomers having between 2 and 4 acrylate functionalities can advantageously be used in radiation-curable coatings for flexible substrates and that the coatings produced exhibit advantageous stain resistance. The Applicant is the first to demonstrate that polyester acrylates oligomers having between 2 and 4 acrylate functionalities produce coatings that may successfully be used to coat flexible substrates while being stain-resistant. Up to now, only polyurethane-based coatings were employed for this use. The Applicant is the first to show that at equivalent flexibility, polyester acrylates-based coatings are more stain resistant than their polyurethane-based counterparts.

As used herein, “radiation curable coating” means a coating, composed of various reactive components, which cures by polymerization through free radical or ionic mechanisms when exposed to ultraviolet (UV) or electron-beam (EB) radiation. Moisture curable and thermoset systems are excluded from radiation curable compositions.

The reactive polyester acrylate oligomer used in the present invention therefore includes substantially any polyester acrylate oligomer characterized by the presence of at least two, preferably three or four, ethylenically unsaturated units (acrylate functions), and which is curable through a free radical-induced polymerization mechanism.

Polyester acrylates oligomers are also characterized by the type of radiation to which they are more sensitive to (such information being usually readily available from their manufacturer). Indeed, some oligomers are more sensitive to either UV or EB radiation, while others can be successfully used with both types of radiation. Accordingly, the type of radiation used for curing the coating of the invention will depend on the exact nature of the polyester acrylate oligomer used and reciprocally.

As used herein the terms “flexible substrate” is meant to refer to any substrate that can be subjected to bending (including rolling) and recover its initial shape without being damaged. Accordingly, the coatings of the invention, which are disposed onto such flexible substrate, are “flexible coatings” that will not be damaged when a coated substrate is bent. More specifically, a flexible substrate is a substrate which is capable of being rolled around a mandrel of 3 inches without being damaged. This substrate may or may not be capable of being rolled around a mandrel of less than 3 inches without being damaged. This means than the coated substrate of the invention, which is tested according to the ASTM F137 norm, is capable of being rolled around a mandrel of 3 inches without crazing or cracking of the coating. This coated substrate may or may not be capable of being rolled around a mandrel of much less than 3 inches without crazing or cracking of the coating. For instance, thinner substrates such as felt may be able to capable of being rolled around a mandrel of ¼ inches without crazing or cracking while and linoleum having a thickness of 2 mm may be able to capable of being rolled around a mandrel of 1¼ inches without crazing or cracking while thicker substrates may not.

The coatings of the present invention may be used in any industrial application where stain-resistant coating of a flexible substrate is desirable. Without being so limited, such applications include covering of flexible substrate including flooring substrate (e.g. plank, vinyl, linoleum, tiles and sheet), wall paper, home furnishing such as countertop, cabinets, cupboards and paneling.

Synthetic substrates that can be coated by the coatings of the present invention include polymeric substrates such as polyvinyl chloride (PVC), acrylonitrile-butadiene-styrene (ABS), acrylonitrile/styrene/acrylate polymer (ASA), polystyrene (PS), high-impact polystyrene (HIPS), polycarbonate (PC), polyolefin (PO) such as polyethylene (PE) and polypropylene (PP), acrylic and sheet molding compound (SMC).

The flexibility of the substrate will dictate the specific coating composition in that the oligomers will desirably contain more or less functionalities depending on whether the substrate is less or more flexible, respectively. More specifically, the more flexible the substrate, the less functionalities will be present in the oligomers used in coatings of the present invention.

The coating compositions of the present invention will usually comprise different components. The coating compositions usually comprise the above-mentioned oligomer (or mixtures thereof); and at least one monofunctional or polyfunctional monomer, or mixtures thereof, which will copolymerize with the oligomer upon exposure to radiation. Without being bound by this particular hypothesis, it is believed that the oligomer imparts primary performance characteristics to the cured film, while the monomers contribute to the degree of crosslinking in the cured film and otherwise function as reactive diluents to adjust the viscosity of the formulation to a level suitable for application.

The coating composition may also further comprise various specialty additives such as filler, colorants, slip agents, release agents, etc. which are added for various end-use properties. The radiation curable coating compositions used in the invention may therefore include a multifunctional polyester acrylate oligomer, a at least one functional monomer, and additional agents such as synthetic waxes, matting agents, and additives.

Typically, the coatings used in the present invention may comprise between about 10.0% to about 90.0% w/w, between 10.0% to about 60.0% w/w, or more typically about 20.0% to about 50.0% w/w of the multifunctional polyester acrylate oligomer.

Typically, the coatings used in the present invention comprise a reactive monomer diluent system. Broadly, suitable reactive monomer diluent systems comprise at least one reactive monomer which will copolymerize with the oligomer upon exposure to radiation. The reactive monomer diluent can be monofunctional or polyfunctional, e.g. di- or tri-functional. A single polyfunctional diluent can be used, as can mixtures thereof. Combinations of one or more monofunctional diluent can also be used as can combinations of at least one polyfunctional diluent and at least one monofunctional diluent. Particularly preferred reactive monomer diluents are unsaturated addition-polymerizable monofunctional and polyfunctional acrylate monomers. Alkoxylated and non-alkoxylated acrylate monomers are useful reactive diluents and are well known.

Preferred alkoxylated acrylate monomers contain from 2-15 alkoxy repeating units. Examples of such acrylate monomers include isobornyl acrylate, phenoxyethyl acrylate, isodecyl acrylate, hexyl acrylate, cyclohexyl acrylate, 2-ethylhexyl acrylate, octyl acrylate, nonyl acrylate, stearyl acrylate, 2-phenoxy acrylate, 2-methoxyethyl acrylate, lactone modified esters of acrylic and methacrylic acid, methyl methacrylate, butyl acrylate, isobutyl acrylate, methacrylamide, allyl acrylate, tetrahydrofuryl acrylate, n-hexyl methacrylate, 2-(2-ethoxyethoxy)ethyl acrylate, n-lauryl acrylate, 2-phenoxyethyl acrylate, glycidyl methacrylate, glycidyl acrylate, acrylated methylolmelamine, 2-(N,N-diethylamino)-ethyl acrylate, neopentyl glycol diacrylate, alkoxylated neopentyl glycol diacrylate, ethylene glycol diacrylate, hexylene glycol diacrylate, diethylene glycol diacrylate, dipropylene glycol diacrylate, tripropylene glycol diacrylate, tetraethylene glycol diacrylate, pentaerythritol di-, tri-, tetra-, or penta-acrylate, trimethylolpropane triacrylate, alkoxylated trimethylol-propane triacrylate which contains from 2 to 14 moles of either ethylene or propylene oxide, triethylene glycol diacrylate, tetraethylene glycol diacrylate, alkoxylated neopentyl glycol diacrylate having from 2 to 15 moles of ethoxy or propoxy units, polyethylene glycol diacrylate, 1,3-butylene glycol diacrylate, 1,4-butanediol diacrylate, 1,6-hexanediol diacrylate, polyethylene glycol diacrylate, combinations thereof, and any corresponding methacrylates, as well as mixtures of any of the above.

As used herein, without being so limited, the term “monofunctional acrylate monomer” is meant to include mono acrylate or methacrylate monomers having a molecular weight of between about 150 and 220 and a viscosity of between about 5 and 15 centipoises. Non limiting examples of such monomers are 2(2 ethoxyethoxy)ethyl acrylate cas number 7328-17-8 (Sartomer SR 256); tetrahydrofurfuryl methacrylate: cas number 2455-24-5 (SR 203); tetrahydrofurfuryl acrylate: cas number 2399-48-6 (SR 285); isooctyl acrylate: cas number 29590-42-9 (SR 440); isodecyl acrylate: cas number 1330-61-6 (SR 395).

As used herein, without being so limited, the term “bi-functional acrylate monomer” includes diacrylates or di methacrylates monomers and in particular diacrylate glycol type monomers. Non limiting examples of such monomers are dipropylene glycol diacrylate: cas number 57472-68-1 (Sartomer SR 508); tripropylene glycol diacrylate: cas number 42978-66-5 (Sartomer SR 306); and neopentyl glycol propoxylate diacrylate: cas number 84170-74-1 (Sartomer SR 9003).

As used herein the term “tri-functional acrylate monomer” is meant to include triacrylate monomers. Non limiting examples of such monomers are tripropylene glycol triacrylate ethoxylated such as (EO)xTMPTA: cas number 28961-43-5; (EO)3 TMPTA (Sartomer SR 454); (EO)6 TMPTA (SR 499); (EO)9 TMPTA (SR 502); and (EO)15 TMPTA (SR 9035).

The flexibility of the substrate will also dictate the specific coating composition in that the monomers used will contain more or less functionalities depending on whether the substrate is less or more flexible, respectively. More specifically, the more flexible the substrate, the less functionalities will be present.

Typically, the coatings of the present invention comprise at least one mono-functional monomer in an amount of about 0.0 to about 20.0% w/w; and/or at least one bi-functional monomer in an amount of about 0.0 to about 30.0% w/w; and/or at least one tri-functional monomer in an amount of about 0.0 to about 30.0% w/w; altogether, the monomers preferably being in an amount of about 20.0 to about 50.0% w/w.

The UV curable coating compositions of the present invention may contain a photoinitiator allowing curing of the polymer material. Compositions without photoinitiators may be cured using electron beam radiation. Such photoinitiators are well known in the art and may be selected based upon the curing conditions used (e.g., curing in an inert environment or in air). Specifically, the initiator may be a free radical photoinitiator, a cationic photoinitiator, or mixtures of both. It should be appreciated that herein the term “photoinitiator” refers indifferently to the initiator both before and after curing. In fact, such initiator may have a different chemical structure or composition before and after exposure to radiation.

The photoinitiator can thus be any known photoinitiator such as acyl phosphine oxide derivatives, benzophenone, benzoin, acetophenone, benzoin methyl ether, Michler's ketone, benzoin butyl ether, xanthone, thioxanthone, propiophenone, fluorenone, carbozole, diethyoxyacetophenone, 1-hydroxy-cyclohexyl phenyl ketone, the 2-, 3- and 4-methylacetophenones and methoxyacetophenones, the 2- and 3-chloroxanthones and chlorothioxanthones, 2-acetyl-4-methylphenyl acetate, 2,2′-dimethyoxy-2-phenylacetophenone, benzaldehyde, fluorene, anthraquinone, triphenylamine, 3- and 4-allyl-acetophenone, p-diacetylbenzene, 3-chloro-2-nonylxanthone, 2-chlorobenzophenone, 4-methoxybenzophenone, 2,2′,4,4′-tetrachlorobenzophenone, 2-chloro-4′-methylbenzophenone, 4-chloro-4′-methylbenzophenone, 3-methylbenzophenone, 4-tert-butyl-benzophenone, isobutyl ether, benzoic acetate, benzil, benzilic acid, amino benzoate, methylene blue, 2,2-diethoxyacetophenone, 9,10-phenanthrenequinone, 2-methyl anthraquinone, 2-ethyl anthraquinone, 1-tert-butyl-anthraquinone, 1,4-naphthoquinone, isopropylthioxanthone, 2-chlorothioxanthone, 2-iso-propylthioxanthone, 2-methylthioxanthone, 2-decylthioxanthone, 2-dodecyl-thioxanthone, 2-methyl-1-[4-(methyl thio)phenyl)]-2-morpholinopropanone-1,2-hydroxy-2-methyl-1-phenylpropanone; oligo 2-hydroxy-2-methyl-1-4 (1-methylvinyl), triarylsulphonium salts, diaryliodonium salts, ferrocenium salts, and combinations thereof.

Typically, photoinitiators are present in the UV-curable coatings of the present invention in an amount of about 1.0% to about 12.0% w/w of the coatings, preferably about 3.0 to about 7.0 w/w of the coatings.

The photoinitiator selected for use in a particular composition will depend on the coating composition and use of the coating. Typically, the photoinitiator will allow for curing in air under standard lamps such as mercury, gallium, iron or lead lamps. Any lamp suitable for such use known to the persons of skill in the art may be used. More specifically, the lamps can be arc lamps, micro-wave lamps, LED lamp, etc. The specific lamp used is selected depending on the nature of the coating (i.e. clear, died, etc.). Mercury lamps are especially appropriate for clear coatings and are well known.

Other optional components may also be present in the coating composition used in the present invention such as additives to control texture, gloss, scratch resistance, rheology, improve surface wetting, promote adhesion, to eliminate foaming, etc.

Typically, the coatings of the present invention may thus also comprise one or more types of particles such as to texturing particles, matting particles and scratch-resistant particles appropriate for coatings.

Upon curing of the coating, texturing particles typically provide texture to the surface of the coating which is normally perceptible to the naked eye. By texture, it is meant that substantially peaks, rises, hills, or bumps, etc. of varying heights are randomly formed on the surface of the coating. Thus, the surfaces of cured coatings including texturing particles are not smooth. Accordingly, the cured, textured coatings can have varying thicknesses which, for example can differ from a first distance between a base of the coating to a first height and a second distance between the base of the coating and a second height by generally from about 1 to about 300 micrometers and preferably from about 2 to about 150 micrometers due to the incorporation of the texture-producing particles therein. The texture-producing particles are randomly, but uniformly distributed throughout the coating layer and preferably can protrude from the surface of the layer. The texture-producing particles can be utilized in the coatings of the present invention to impart varying degrees of texture ranging from relatively fine, yet visible texture, to more visually apparent coarse textures. Texture-producing particles can have average particle sizes which are less than, substantially equal to, or slightly greater than the thickness of the coating after it has been applied to and cured on a substrate. Generally, the degree of texture imparted by the texture-producing particles can be controlled by varying the ratio of the particle size of the particles in relation to the thickness of the coating

Without being so limited, inorganic materials suitable as texturing particles include, but are not limited to, alumina, alumina derivatives such as alumino silicates, alumina coated on silica, ceramic, glass, silica, or combinations thereof. Organic materials suitable as texturing particles include, but are not limited to, thermoplastic and thermosetting polymers or copolymers, and solid waxes, microspheres and/or beads thereof, etc. They include polyamides, including nylons such as nylon 6 and nylon 12, polyethylene, polypropylene, fluorinated polymers such as polytetrafluoroethylene, urea-formaldehyde or combinations thereof. More particularly, they include polypropylene wax powder such as Propyltex® (MPI); polyolefin crystalline wax powders such as the texture series from Shamrock; polymethyl methacrylate sphere powders such as texmatte 6000® (Shamrock) and polyamide particles such as Orgasol™.

The texturing particles when used in specific embodiments of the present invention have average particle sizes generally from about 10 to about 150 micrometers, and preferably from about 15 or about 18 to about 75 micrometers. In specific embodiments, the texture-producing particles are utilized in the coating compositions of the present invention in amounts generally up to about 20% by weight, desirably from about 2% to about 15% by weight and preferably from about 4% to about 10% by weight, based on the total weight of the coating composition. Any combination of texture-producing particles noted herein can be utilized in a single coating composition.

Matting/flatting agents such as silica, may be added to reduce or control the level of gloss in the cured coating. Flatting agents are well known in the art. Preferred flatting agents include organic particles having a size of approximately 0.1-100 microns, inorganic particles having a size of approximately 0.1-100 microns, or mixtures of both.

When flatting agents are used, a dispersant/coupling agent may be needed to obtain good dispersion in the liquid coating and good adhesion between the particles and the cured coating. For inorganic flatting agents, preferred dispersants are organosilanes, mixtures of organosilanes, and low surface tension monomers and oligomers. For organic flatting agents, preferred dispersant include organosilanes, mixtures of organosilanes, and low surface tension monomers and oligomers.

More preferred flatting agents include silica, such as Siloid™, alumina, polypropylene, polyethylene, waxes, ethylene copolymers, polyamide, polytetrafluoroethylene, urea-formaldehyde and combinations thereof. The concentration of the flatting agent may be approximately 1-25%, by weight, of the liquid coating mixture, and more preferably is 1-20%, by weight. Low gloss may also be achieved by using a two-steps curing procedure. Without being so limited, preferred matting particles include synthetic amorphous silicas, polypropylene wax particles such as those from MPI, Shamrock, Lanco; and silica particles such as those from Inéos and Grace. In specific embodiments of the present invention they are in a concentration of 1 to 16% w/w.

Without being so limited, scratch-resistant particles include waxes such as polytetrafluoroethylene (PTFE); aluminum oxide; silicon dioxide, ceramic particles including naturally occurring and synthetically produced such as silica and alumina or alkali alumino silicate ceramic such as 3M Zeeospheres™ and 3M W410. Scratch-resistant particles of the present invention may also be mixtures of various particles include the above-listed types of particles. The concentration of the scratch-resistant particles may be approximately 5%-30%, by weight, of the liquid coating mixture, preferably from 8-25%.

Typically, these particles are present in the coatings of the present invention in a combined amount (i.e. all types of particles combined) of about 5 to about 35% w/w and more preferably about 15 to about 20% w/w.

The coatings of the present invention may also comprise other types of additives known to those skilled in the art coatings formulation. The amount of optional component will depend on the purpose and type of the additive used and can be determined by one skilled in the art. Without being so limited, such additional additives include anti-foaming agents (defoamers), dispersants, fillers, plasticizers, antioxidants, optical brighteners, stabilizers, wetting agents, anti-mildew agents, fungicides, surfactants, adhesion promoters, colorants, dyes, pigments, slip agents, fire and flame retardants, release agents, rheological agents, matting/flatting agents, suspension aids, texturing agents and spreading/leveling agents.

The additives of the present invention other than powders described above typically amount altogether from about 1.0 to about 6.0%, preferably from about 1 to about 5% w/w or from about 3.0% to about 4.0% w/w of the coatings.

Suspension aids may be used to prevent the settling of the scratch-resistant particles, in the liquid coating formulation. The suspension aid can be a polymer comprising a polyamine amide, a polyamide, or an unsaturated polycarboxylic acid including a high molecular weight version of either one of these polymers, a polymer comprising a carboxylic acid salt of a polyamine amide, a phosphoric acid salt of a long chain carboxylic acid polyamine amide or a solution of a partial amide and alkylammonium salt of a higher molecular weight unsaturated polycarboxylic acid and polysiloxane copolymer or a combination or mixtures of various suspension aids. Specific examples of such polymers include, but are not limited to Anti-Terra™ polymers from BYK CHEMIE such as Anti-Terra™ 202, Anti-Terra™ 205, Anti-Terra™ 204, Anti-Terra™ P, Anti-Terra™ U-80, BYK-P-105, Anti-Terra™ U and Lactimon type suspension aids; Disparlon™ 6500 polyamide thixotrope from King Industries; suspension aids described in U.S. Pat. No. 4,795,796. Typically a solvent, such as a non-aqueous solvent is present with the suspension aid, such as butyl acetate, xylene, PMA, methoxy propylacetate, and alcohols such as isobutanol and methoxypropanol.

An anti-foaming agent or defoamer may be used in the coating formulation to reduce or prevent any foaming resulting from the high shear rates which are generally used to introduce the scratch-resistant particles into the coating formulations of the present invention. Without being so limited, useful anti-foaming agents include silicon defoamer such as BYK CHEMIE BYK 011, 019, 020, 022, 024, 025, 028, 065, 066N, 080A, 088 and 141 or silicon free defoamer such as BYK CHEMIE A-500 or air-release acrylate BYK 354.

Wetting and dispersant additives may also be added for purpose of aiding the dispersion of any particle in the liquid coating mixture. Without being so limited, useful dispersants include Solsperse™ 32000, 41000 and 71000. Suspension aids may also play the role of dispersants. Wetting and/or dispersing additives include BYK 111, DISPERBYK 111, P104, P104S and P105.

Stabilizers may also be added for purpose of avoiding premature polymerization during the manufacture and storage of the coating (i.e. thermal stabilizer). Without being so limited, useful stabilizers for such purpose include Additol™ S100, S110 and S120 from Cytec, Florstab™ UV1, UV5, UV8, UV11 and UV12 from Kromachem. Stabilizers can also be used for avoiding degradation of the resins in the coating caused by natural UV over time (i.e. light stabilizers). Without being so limited, useful stabilizers for this purpose include Tinuvin™ 328, 384, 1130, 400, 123, 292 and 5151 from Ciba.

A rheological control agent may be used in the coating formulation, particularly if the coating does not have an inherent viscosity that is high enough to form a macroscopic texture upon application of the pre-cured coating mixture to a substrate. The rheological control agent may be inorganic particles, organic solids, and mixtures of both.

The formulation of the coatings of the present invention may be adapted depending on the nature of the substrate that it will cover (e.g. flexible/resilient, semi-rigid substrates); depending on the conditions of application (e.g. temperature of substrate and of coating, type of lamp used, type of substrate); depending on the curing conditions (e.g. air-cured, under inert gas atmosphere (e.g. nitrogen), etc.); and depending on the desired finish (e.g. smooth or textured; high-gloss, semi-gloss, matte, etc.).

The conditions of application of the coating (i.e. coating and substrate temperature and energy applied) may influence the coating gloss and consequently the coating formulation.

The curing conditions of the coating may influence its formulation. For example, increasing the energy applied for curing will decrease the concentration of photoinitiator necessary to achieve cross-linking. Similarly, using more photoinitiator will require less energy to cross-link the ingredients.

The coating formulations may also be adapted depending on the desired finish. For instance, a textured surface or a smooth surface will be obtained by including or not texturing powders, respectively. The appearance of the cured coating will be high-gloss, semi-gloss or matte depending on the curing procedure used and the powders used (matting agent, texturing agent). Hence, a two-steps curing procedure can be used for instance to obtain a matte appearance.

Typically, the coatings of the present invention are prepared as follows. The liquid ingredients are first mixed in a high speed disperser, ⅔ of the oligomer and ½ of the monomers along with liquid additives, such as antifoaming agents, dispersants and stabilizers. The particles are dispersed in the liquids at high speed. The temperature desirably does not increase over 65° C. The remaining ingredients are then added: ⅓ oligomer, ½ monomer, the photoinitiator and spreading/leveling agents. Of course different additives can be used depending on the specific coating produced.

According to preferred embodiments, the coatings are applied on flexible vinyl-containing substrates. Preferably, on that type of substrate, the thickness of the cured coating is of about 10 to about 30 microns and preferably 20-25 microns. The maximum thickness of the coating is dictated by the brittleness of thicker coating.

According to preferred embodiments, the coatings of the present invention may be cured by photo radiation with a lamp of about 200 to 600 watts/inch.

For low gloss coating, the curing is preferably conducted in two steps. The coating is first cured at an energy of about 30 to 300 mJ, preferably 70-150 mJ under oxygen atmosphere. Then the coating is cured at an energy of about 250-2000 mJ, preferably 750-1300 mJ and preferably under inert atmosphere.

For other coatings, single-step curing is appropriate. The energy used is of about 250-2000 mJ, preferably 750-1300 mJ under an inert atmosphere.

Other objects, advantages and features of the present invention will become more apparent upon reading of the following non-restrictive description of specific embodiments thereof, given by way of example only with reference to the accompanying drawings.

In particular, it is to be noted that the coating composition described in the examples below can also be easily produced without a photoinitiator.

### EXAMPLE 1

### Technical Characteristics of the Oligomers Used in the Examples Presented Herein

The oligomers 1 to 26 presented in Table 1 below were used in the Examples presented herein. This table provides different technical characteristics for each of these oligomers.

TABLE 1
Technical characteristics of the polyester-acrylates oligomers used

| | | | | | | | | Break |
|---|---|---|---|---|---|---|---|---|
| | Trade | | | | | Molecular | | elongation |
| # | name | Backbone | Source | Functionality | Density | Weight | Tg (° C.) | (%) |
| 1 | CN 2281 | polyester | Sartomer | 3 | 1.1 | 600–1500 | 33 | 17 |
| 2 | CN 2251 | polyester | Sartomer | 3 | 1.2 | 600–1500 | 37 | 1 |
| 3 | CN 2258 | polyester | Sartomer | 3 | 1.1 | 600–1500 | 55 | 10 |
| 4 | CN 2259 | polyester | Sartomer | 3 | 1.2 | 600–1500 | 45 | 11 |
| 5 | Eb 809 | polyester | Cytec | 3.5 | 1.1 | 600–1500 | 54 | 18 |
| 6 | LR 8800 | polyester | Basf | 3.5 | 1.2 | 600–1500 | 33 | 2 |
| 7 | LR 8981 | polyester | Basf | 3.5 | 1.1 | 600–1500 | 10 | 17 |
| 8 | PE 44F | polyester | Basf | 3.5 | 1.2 | 600–1500 | 39 | 5 |
| 9 | CN 2282 | polyester | Sartomer | 4 | 1.2 | 600–1500 | 36 | 20 |
| 10 | CN 2253 | polyester | Sartomer | 4 | 1.2 | 600–1500 | 40 | 9 |
| 11 | CN 2257 | polyester | Sartomer | 4 | 1.1 | 600–1500 | 63 | 2 |
| 12 | CN 2262 | polyester | Sartomer | 4 | 1.1 | 600–1500 | 31 | 10 |
| 13 | Eb 810 | polyester | Cytec | 4 | 1.1 | 600–1500 | 31 | 6 |
| 14 | Eb 657 | polyester | Cytec | 4 | 1.0 | 600–1500 | 33 | 23 |
| 15 | LR 8992 | polyester | Basf | 4 | 1.2 | 600–1500 | NA | NA |
| 16 | CN 929 | polyurethane | Sartomer | 3 | 1.1 | 1000–3000 | 43 | 62 |
| 17 | CN 989 | polyurethane | Sartomer | 3 | 1.2 | 1000–3000 | 72 | 17 |
| 18 | CN 2901 | polyurethane | Sartomer | 3 | 1.1 | 1000–3000 | 35 | 22 |
| 19 | Eb 8210 | polyurethane | Cytec | 3.5 | 1.1 | 600–1500 | 68 | 2 |
| 20 | Eb 8302 | polyurethane | Cytec | 3.5 | 1.3 | 600–1500 | 70 | 1 |
| 21 | Eb 8405 | polyurethane | Cytec | 4 | 1.1 | 600–1500 | 30 | 29 |
| 22 | CN 964 | polyurethane | Sartomer | 2 | 1.1 | 1000–3000 | −24 | 98 |
| 23 | CN 981 | polyurethane | Sartomer | 2 | 1.1 | 1000–3000 | 22 | 79 |
| 24 | CN 984 | polyurethane | Sartomer | 2 | 1.1 | 1000–3000 | 24 | 53 |
| 25 | CN 9893 | polyurethane | Sartomer | 2 | 1.2 | 1000–3000 | 13 | 160 |
| 26 | Eb 8402 | polyurethane | Cytec | 2 | 1.1 | 600–1500 | 14 | 90 |

Tg: Glass Transition Temperature

### EXAMPLE 2

### Polyurethane and Polyester Formulations

The polyester acrylates and aliphatic acrylate urethanes-based coatings tested in Examples 3 to 11 herein comprised the following:

| | |
|---|---|
| One of the bi to tetra-functional oligomers of Table 1 | 43% w/w |
| Bi-functional neopentyl glycol propoxylate diacrylate SR | 27% w/w |
| 9003 (monomer) | |
| Alumino silicate ceramic 3M W410 | 10% w/w |
| (Scratch-resistant) | |
| Siloid ™ silica | 5% w/w |
| (Matting wax) | |
| Texturing polypropylene wax Shamrock Ultrafine ™ | 6% w/w |
| (texturing particles) | |
| Irgacure ™ 1173 | 5% w/w |
| (Photoinitiator) | |
| BYK 354, 1% (defoamer) | 4% |
| FLOSTSTAB UV5, 1% (stabilizer) | |
| DISPERBYK 111, 1% (dispersing agent) | |
| BYK 348 0.5% (leveling agent) | |
| BYK 371 0.5% (leveling agent) | |

Two thirds (⅔) of the oligomer and half (½) of the monomers along with the defoamer, the stabilizer and the dispersant were first mixed in a high speed disperser. The particles listed above (i.e. the scratch-resistant particles, the matting agent and the texture particles) were then dispersed in the liquids at high speed. The temperature was maintained between 40 to 70° C. The remaining ingredients were then added: i.e. a third (⅓) of the oligomer, the second half (½) of the monomer, the photoinitiator and the leveling agents.

### EXAMPLE 3

### Application of the Coatings on Flexible Substrates

The coatings were applied on a flexible vinyl-containing substrate to reach a thickness of about 20 to about 25 microns. The temperature of the liquid before application was 60° C. The application was performed with a rod 14.

### EXAMPLE 4

### Curing Conditions

The coatings were cured by photo radiation with a mercury lamp of 300 watts/inch. The coating was first cured at an energy of 80 mJ under oxygen atmosphere. Then the coatings were cured at an energy of about 1200 mJ under an inert atmosphere.

### EXAMPLE 5

### Viscosity Determination

The coatings viscosity was measured at a temperature of about 22° C. with a Brookfield™ viscometer. Viscosity was expressed in centipoises. See Tables 2 to 8 below.

### EXAMPLE 6

### Flexibility Determination

The coatings flexibility was measured with a mandrel. The coated substrate was rolled around the metal stick having a diameter of ¼ to ½ inch. The flexibility was measured when the coating showed crazing (cracking). The flexibility data reported in the tables below is therefore the size (in inch) of the smallest metal stick tested around which the substrate can be rolled without causing crazing (cracking) of the coating.

### EXAMPLE 7

### Gloss Determination

The coatings gloss was measured with a glossmeter at angles 60 and 85 degrees. These measurements are reported in the tables below. In these tables, 6/12 (for example) means 6% gloss at 60° C. and 12% gloss at 85° C. The ASTM method D1308 was used to measure the gloss.

### EXAMPLE 8

### Aging Rate Determination

The coatings' aging rate was measured by subjecting all samples simultaneously to 50 cycles of aging under UV radiation at an energy 700 mJ and at a temperature between about 45 and about 50° C. Samples were measured before and after aging with a spectrophotometer BYK. The results of this test are reported in the tables below in the column titled “De coating” and “De coating after aging”. The higher the number reported, the larger the difference in color between: the uncoated and the coated substrate (De coating column); and between the coated substrate and the coated substrate after aging (De coating after aging column).

### EXAMPLE 9

### Staining

Polyester acrylate-based and urethane acrylate-based coatings were stained with dark brown Kiwi™ shoe polish (staining agent # 1); French™ mustard (staining agent # 2); and blue Sharpie™ permanent felt pen (staining agent # 3). These agents are routinely used in the vinyl flooring industry because of their known staining power. The staining agents were applied uniformly with a spatula on the coated vinyl so as to produce a homogenous stain of about three centimeters of diameter. Each type of staining agents was left on the coatings for durations of one (1) hour or twenty-four (24) hours. The agents were removed after the specific delays, and the stains were washed without applying any pressure with a soft cloth lightly moistened with isopropyl alcohol. The samples were measured before and after the staining with a Spectrophotometer BYK. The results of this test are reported in the tables below in the columns titled “Staining agent #”. The higher the number reported for De, the larger the difference in color between the stained and unstained coated substrate. A better strain-resistance is therefore indicated by a smaller De.

### EXAMPLE 10

### Comparison of Flexibility of Polyester Acrylate and Urethane Acrylate-Based Coatings

Polyester acrylate (PE) and urethane acrylate-based (PU) coatings of functionalities 3, 3.5 and 4 were tested and the results are presented in Tables 2 and 3, respectively. These results show that at equivalent functionality, PE flexibility is better than that of PU. One third ( 5/15) of the polyester acrylate-based coatings reached a flexibility of 4, a little more than half ( 8/15) reached a flexibility of between ½ and ¼, and only a little more than a tenth ( 2/15) reached a flexibility of ½. In comparison, a little less than a fifth (⅙) of the urethane acrylate-based coatings reached a flexibility of ¼, a third ( 2/6) reached a flexibility of between ½ and ¼, and half ( 3/6) reached a flexibility of ½.

TABLE 2
Polyester acrylate-based coatings

| | | | | | | | De Staining | | De Staining | | De Staining | | |
|---|---|---|---|---|---|---|---|---|---|---|---|---|---|
| | | | | | | | agent # 1 | | agent # 2 | | agent # 3 | | |
| | | | Viscosity | Gloss | De | De Coating | | After | After | After | | After | |
| # | Oligomer | fn | (cps) | 60/85 | Coating | after aging | After 1 h | 24 h | 1 h | 24 h | After 1 h | 24 h | Flexibility |
| PE 1 | CN 2281 | 3 | 760 | 6/12 | 0.46 | 4.04 | 49.88 | 66.98 | 1.81 | 18.14 | 14.38 | 15.75 | ¼ |
| PE 2 | CN 2251 | 3 | 3305 | 30/30 | 1.39 | 4.69 | 6.25 | 12.09 | 0.66 | 1.31 | 3.57 | 6.44 | ¼ to ½ |
| PE 3 | CN 2258 | 3 | 5620 | 6/20 | 1.01 | 3.93 | 36.83 | 64.77 | 0.93 | 9.98 | 7.82 | 23.23 | ¼ |
| PE 4 | CN 2259 | 3 | 1950 | 8/25 | 1.53 | 4.38 | 5.32 | 12.63 | 1.04 | 1.15 | 4.8 | 3.29 | ¼ to ½ |
| PE 5 | Eb 809 | 3.5 | 1315 | 6/20 | 1.49 | 6.4 | 41.94 | 68.67 | 0.49 | 18.83 | 11.21 | 19.28 | ¼ |
| PE 6 | LR 8800 | 3.5 | 1000 | 15/23 | 1.53 | 4.03 | 8.68 | 9.01 | 0.71 | 0.78 | 2.09 | 4.63 | ½ |
| PE 7 | LR 8981 | 3.5 | 770 | 6/19 | 1.54 | 6.65 | 41.07 | 68.44 | 2.76 | 16.36 | 10.94 | 25.65 | ¼ |
| PE 8 | PE 44F | 3.5 | 800 | 9/19 | 1.08 | 4.87 | 33.78 | 67.99 | 0.71 | 14.05 | 10.71 | 19.34 | ¼ |
| PE 9 | CN 2282 | 4 | 2935 | 7/20 | 0.95 | 4.36 | 8.38 | 33.91 | 0.76 | 2.6 | 5.84 | 10.73 | ¼ to ½ |
| PE 10 | CN 2253 | 4 | 26.21 | 9/22 | 1.38 | 4.61 | 5.12 | 11.8 | 0.86 | 1.05 | 3.38 | 5.59 | <½ |
| PE 11 | CN 2257 | 4 | 3145 | 9/23 | 1.04 | 3.97 | 21.18 | 50.05 | 0.76 | 1.03 | 7.23 | 7.51 | ¼ to ½ |
| PE 12 | CN 2262 | 4 | 750 | 9/16 | 1.41 | 4.16 | 22.72 | 61.78 | 0.84 | 0.92 | 7.94 | 8.04 | ¼ to ½ |
| PE 13 | Eb 810 | 4 | 760 | 13/17 | 1.16 | 3.78 | 25.87 | 60.1 | 0.44 | 0.47 | 5.31 | 11.24 | ¼ to ½ |
| PE 14 | Eb 657 | 4 | 6065 | 25/27 | 1.62 | 4.76 | 25.78 | 59.23 | 0.61 | 0.9 | 7.59 | 9.25 | ¼ to ½ |
| PE 15 | LR 8992 | 4 | 1465 | 6/19 | 1.08 | 5.62 | 20.29 | 56.52 | 0.49 | 0.94 | 10.92 | 12.25 | ¼ to ½ |

fn = number of acrylate functionalities in the oligomer used

TABLE 3
Urethane acrylate-based coatings of functionalities 3 to 4

| | | | | | | | De Staining | | De Staining | | De Staining | | |
|---|---|---|---|---|---|---|---|---|---|---|---|---|---|
| | | | | | | | agent # 1 | | agent # 2 | | agent # 3 | | |
| | | | Viscosity | Gloss | De | De Coating | After | After | After | After | After | After | |
| # | Oligomer | fn | (cps) | 60/85 | Coating | after aging | 1 h | 24 h | 1 h | 24 h | 1 h | 24 h | Flexibility |
| PU 16 | CN 929 | 3 | 4955 | 7/20 | 1.47 | 5.49 | 56.62 | 86.05 | 3.22 | 21.37 | 22.43 | 36.43 | ¼ |
| PU 17 | CN 989 | 3 | 11815 | 9/21 | 0.91 | 3.82 | 6.35 | 27.46 | 1.04 | 1.05 | 3.71 | 6.81 | ½ |
| PU 18 | CN 2901 | 3 | 4810 | 5/19 | 1.43 | 5.91 | 53.67 | 68.97 | 0.32 | 2.82 | 15.17 | 26.92 | ¼ to ½ |
| PU 19 | Eb 8210 | 3.5 | 1550 | 19/25 | 1.26 | 2.41 | 0.85 | 4.78 | 2.12 | 3.04 | 1.37 | 1.43 | ½ |
| PU 20 | Eb 8302 | 3.5 | 1620 | 16/26 | 1.18 | 2.92 | 2.05 | 10.08 | 1.86 | 2.71 | 2.79 | 3.54 | <½ |
| PU 21 | Eb 8405 | 4 | 7545 | 5/16 | 1.05 | 5.51 | 36.54 | 70.55 | 0.85 | 0.98 | 16.56 | 20.77 | ¼ to ½ |

Most urethane acrylate-based coatings that reached a flexibility of ¼ are urethane acrylate-based coatings having a functionality of 2 (see Table 4 below).

TABLE 4
Urethane acrylate-based coatings of functionality 2

| | | | | | | | De Staining | | De Staining | | De Staining | | |
|---|---|---|---|---|---|---|---|---|---|---|---|---|---|
| | | | | | | | agent # 1 | | agent # 2 | | agent # 3 | | |
| | | | Viscosity | Gloss | De | De Coating | After | After | After | After | After | After | |
| # | Oligomer | fn | (cps) | 60/85 | Coating | after aging | 1 h | 24 h | 1 h | 24 h | 1 h | 24 h | Flexibility |
| PU | CN 964 | 2 | 10955 | 9/22 | 0.85 | 3.87 | 62.65 | 82.25 | 9.87 | 20.11 | 25.14 | 37.25 | ¼ |
| 22 | | | | | | | | | | | | | |
| PU | CN 981 | 2 | 9110 | 11/25 | 1.04 | 4.84 | 40.03 | 78.96 | 6.61 | 18.52 | 26.94 | 33.39 | ¼ |
| 23 | | | | | | | | | | | | | |
| PU | CN 984 | 2 | 3160 | 6/22 | 1.23 | 4.53 | 72.53, | 82.79 | 15.62 | 26.21 | 20.46 | 30.87 | ¼ |
| 24 | | | | | | | | | | | | | |
| PU | CN 9893 | 2 | 17230 | 9/24 | 1.22 | 4.93 | 59.07 | 88.71 | 10.44 | 27.22 | 15.76 | 25.95 | ¼ to ½ |
| 25 | | | | | | | | | | | | | |
| PU | Eb 8402 | 2 | 3450 | 7/22 | 1.41 | 4.93 | 64.78 | 85.34 | 12.19 | 20.96 | 17.11 | 28.75 | ¼ |
| 26 | | | | | | | | | | | | | |

In view of the data present herein, but without being limited to this particular hypothesis, Applicant submits that the coatings stain resistance increases with the oligomer functionality (i.e. increased cross-linking density) while their flexibility decreases.

### EXAMPLE 11

### Comparison of Staining Resistance of Polyester Acrylate and Urethane Acrylate-Based Coatings at Equivalent Flexibility

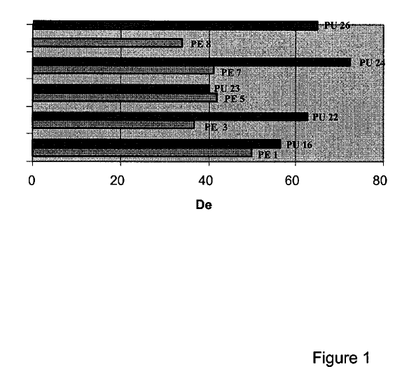

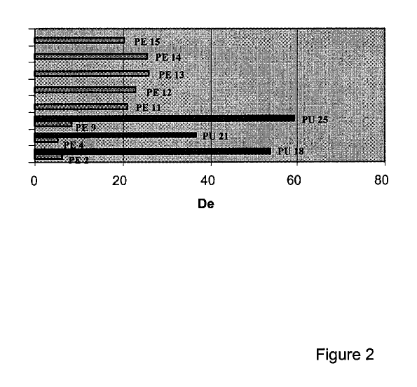

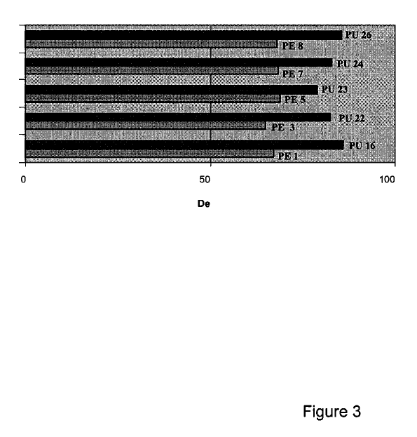

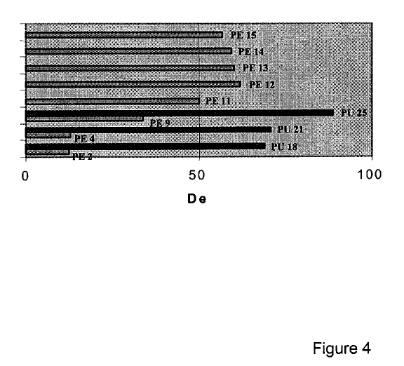

The staining resistance of the polyester acrylate and urethane acrylate-based coatings were then compared at equivalent flexibility, namely at ¼, and between ¼ and ½. Results show that at equivalent flexibility, polyester acrylate-based coatings are more stain-resistant than urethane acrylate-based coatings (see Tables 5-8 below and FIGS. 1-4).

TABLE 5
Polyester acrylate-based coatings having a flexibility of ¼

| | | | | | | | | De Staining | | De Staining | | De Staining | |
|---|---|---|---|---|---|---|---|---|---|---|---|---|---|
| | | | | | | | | agent 1 | | agent 2 | | agent 3 | |
| | | | viscosity | gloss | | De After | De After | | After | | After | | After |
| # | oligomer | fn | cps | 60/85 | flexibility | coating | aging | After 1 h | 24 h | After 1 h | 24 h | After 1 h | 24 h |
| PE 1 | CN 2281 | 3 | 760 | 6/12 | ¼ | 0.46 | 4.04 | 49.88 | 66.98 | 1.81 | 18.14 | 14.38 | 15.75 |
| PE 3 | CN 2258 | 3 | 5620 | 6/20 | ¼ | 1.01 | 3.93 | 36.83 | 64.77 | 0.93 | 9.98 | 7.82 | 23.23 |
| PE 5 | Eb 809 | 3.5 | 1315 | 6/20 | ¼ | 1.49 | 6.4 | 41.94 | 68.67 | 0.49 | 18.83 | 11.21 | 19.28 |
| PE 7 | LR 8981 | 3.5 | 770 | 6/19 | ¼ | 1.54 | 6.65 | 41.07 | 68.44 | 2.76 | 16.36 | 10.94 | 25.65 |
| PE 8 | PE 44F | 3.5 | 800 | 9/19 | ¼ | 1.08 | 4.87 | 33.78 | 67.99 | 0.71 | 14.05 | 10.71 | 19.34 |

| | | | | | | |
|---|---|---|---|---|---|---|
| Average De | 40.7 | 67.37 | 1.34 | 15.472 | 11.012 | 20.65 |

TABLE 6
Urethane acrylate-based coatings having a flexibility of ¼

| | | | | | | | | De Staining | | De Staining | | De Staining | |
|---|---|---|---|---|---|---|---|---|---|---|---|---|---|
| | | | | | | | | agent 1 | | agent 2 | | agent 3 | |
| | | | viscosity | gloss | | De After | De After | | After | After | After | After | After |
| # | oligomer | fn | cps | 60/85 | flexibility | coating | aging | After 1 h | 24 h | 1 h | 24 h | 1 h | 24 h |
| PU 16 | CN 929 | 3 | 4955 | 7/20 | ¼ | 1.47 | 5.49 | 56.62 | 86.05 | 3.22 | 21.37 | 22.43 | 36.43 |
| PU 22 | CN 964 | 2 | 10955 | 9/22 | ¼ | 0.85 | 3.87 | 62.65 | 82.25 | 9.87 | 20.11 | 25.14 | 37.25 |
| PU 23 | CN 981 | 2 | 9110 | 11/25 | ¼ | 1.04 | 4.84 | 40.03 | 78.96 | 6.61 | 18.52 | 26.94 | 33.39 |
| PU 24 | CN 984 | 2 | 3160 | 6/22 | ¼ | 1.23 | 4.53 | 72.53, | 82.79 | 15.62 | 26.21 | 20.46 | 30.87 |
| PU 26 | Eb 8402 | 2 | 3450 | 7/22 | ¼ | 1.41 | 4.93 | 64.78 | 85.34 | 12.19 | 20.96 | 17.11 | 28.75 |

| | | | | | | |
|---|---|---|---|---|---|---|
| Average De | 44.82 | 83.08 | 9.5 | 21.43 | 22.42 | 33.34 |

TABLE 7
Polyester acrylate-based coatings having a flexibility of between ¼ and ½

| | | | | | | | | De Staining | | De Staining | | De Staining | |
|---|---|---|---|---|---|---|---|---|---|---|---|---|---|
| | | | | | | | | agent 1 | | agent 2 | | agent 3 | |
| | | | viscosity | gloss | | De After | De After | After | After | After | After | After | After |
| # | oligomer | fn | cps | 60/85 | flexibility | coating | aging | 1 h | 24 h | 1 h | 24 h | 1 h | 24 h |
| PE 2 | CN 2251 | 3 | 3305 | 30/30 | ¼ à ½ | 1.39 | 4.69 | 6.25 | 12.09 | 0.66 | 1.31 | 3.57 | 6.44 |
| PE 4 | CN 2259 | 3 | 1950 | 8/25 | ¼ à ½ | 1.53 | 4.38 | 5.32 | 12.63 | 1.04 | 1.15 | 4.8 | 3.29 |
| PE 9 | CN 2282 | 4 | 2935 | 7/20 | ¼ à ½ | 0.95 | 4.36 | 8.38 | 33.91 | 0.76 | 2.6 | 5.84 | 10.73 |
| PE 11 | CN 2257 | 4 | 3145 | 9/23 | ¼ à ½ | 1.04 | 3.97 | 21.18 | 50.05 | 0.76 | 1.03 | 7.23 | 7.51 |
| PE 12 | CN 2262 | 4 | 750 | 9/16 | ¼ à ½ | 1.41 | 4.16 | 22.72 | 61.78 | 0.84 | 0.92 | 7.94 | 8.04 |
| PE 13 | Eb 810 | 4 | 760 | 13/17 | ¼ à ½ | 1.16 | 3.78 | 25.87 | 60.1 | 0.44 | 0.47 | 5.31 | 11.24 |
| PE 14 | Eb 657 | 4 | 6065 | 25/27 | ¼ à ½ | 1.62 | 4.76 | 25.78 | 59.23 | 0.61 | 0.9 | 7.59 | 9.25 |
| PE 15 | LR 8992 | 4 | 1465 | 6/19 | ¼ à ½ | 1.08 | 5.62 | 20.29 | 56.52 | 0.49 | 0.94 | 10.92 | 12.25 |

| | | | | | | |
|---|---|---|---|---|---|---|
| Average De | 16.97 | 43.29 | 0.70 | 1.17 | 6.65 | 8.59 |

TABLE 8
Urethane acrylate-based coatings having a flexibility of between ¼ and ½

| | | | | | | | | De Staining | | De Staining | | De Staining | |
|---|---|---|---|---|---|---|---|---|---|---|---|---|---|
| | | | | | | | | agent 1 | | agent 2 | | agent 3 | |
| | | | viscosity | gloss | | De After | De After | | After | | After | After | After |
| # | oligomer | fn | cps | 60/85 | flexibility | coating | aging | After 1 h | 24 h | After 1 h | 24 h | 1 h | 24 h |
| PU 18 | CN 2901 | 3 | 4810 | 5/19 | ¼ à ½ | 1.43 | 5.91 | 53.67 | 68.97 | 0.32 | 2.82 | 15.17 | 26.92 |
| PU 21 | Eb 8405 | 4 | 7545 | 5/16 | ¼ à ½ | 1.05 | 5.51 | 36.54 | 70.55 | 0.85 | 0.98 | 16.56 | 20.77 |
| PU 25 | CN 9893 | 2 | 17230 | 9/24 | ¼ à ½ | 1.22 | 4.93 | 59.07 | 88.71 | 10.44 | 27.22 | 15.76 | 25.95 |

| | | | | | | |
|---|---|---|---|---|---|---|
| Average De | 49.76 | 76.08 | 3.87 | 10.34 | 15.83 | 24.55 |

Although the present invention has been described hereinabove by way of specific embodiments thereof, it can be modified without departing from the spirit and nature of the subject invention as defined in the appended claims.

1. A coated flexible substrate comprising:
(a) a flexible substrate, and
(b) a coating disposed on at least a portion of said substrate,
wherein said coating is manufactured by radiation curing a liquid coating composition comprising at least one polyester acrylate-based oligomer having between 2 and 4 acrylate functionalities and at least one acrylate monomer.

2. The coated substrate of claim 1, wherein the substrate is a flooring substrate.

3. The coated substrate of claim 2, wherein the substrate is vinyl.

4. The coated substrate of claim 1, wherein the oligomer has 2 acrylate functionalities.

5. The coated substrate of claim 1, wherein the oligomer has 2.5 acrylate functionalities.

6. The coated substrate of claim 1, wherein the oligomer has 3 acrylate functionalities.

7. The coated substrate of claim 1, wherein the oligomer has 3.5 acrylate functionalities

8. The coated substrate of claim 1, wherein the oligomer has 4 acrylate functionalities.

9. The coated substrate of claim 1, wherein the coating comprises between about 20.0% and about 50.0% wow of the oligomer.

10. The coated substrate of claim 1, wherein the coating comprises between about 20.0% and about 50.0% w/w of the monomer.

11. The coated substrate of claim 10, wherein the monomer is mono-functional.

12. The coated substrate of claim 10, wherein the monomer is bifunctional.

13. The coated substrate of claim 1, wherein the monomer is tri-functional.

14. The coated substrate of claim 1, wherein the monomer is neopentyl glycol propoxylate diacrylate.

15. The coated substrate of claim 1, wherein the coating further comprises a photoinitiator.

16. The coated substrate of claim 15, wherein the coating comprises between about 3.0% to about 7.0% w/w of the photoinitiator.

17. The coated substrate of claim 1, wherein the coating further comprises at least one type of particles.

18. The coated substrate of claim 17, wherein the coating comprises between about 5.0% and about 35.0% w/w of particles.

19. The coated substrate of claim 18, wherein the particles are selected from the group consisting of texturing particle, matting particle, scratch-resistant particles and combinations thereof.

20. The coated substrate of claim 19, wherein the matting particle is silica.

21. The coated substrate of claim 19, wherein the scratch-resistant particle is a ceramic.

22. The coated substrate of claim 19, wherein the texturing particle is a polypropylene wax.

23. The coated substrate of claim 1, wherein the coating further comprises at least one additive.

24. The coated substrate of claim 23, wherein the additive is in a concentration of about 1.0% to about 5% w/w of the composition.

25. The coated substrate of claim 23, wherein the additive is selected from an anti-foaming agent, a dispersant, a stabilizer, a leveling agent and mixtures thereof.

26. A method of coating a flexible substrate comprising the step of:
(a) disposing a coating composition comprising at least one acrylic monomer and a polyester acrylate-based oligomer having between 2 and 4 acrylate functionalities on at least one portion of said flexible substrate; and
(b) radiation curing said composition.

27. The method of claim 26, wherein the coating is as defined in any one of claims 1 to 25.

28. The method of claim 26, wherein the substrate is a flooring substrate.

29. The method of claim 28, wherein the substrate is vinyl.

30. The method of claim 26, wherein the coating is between about 10 and about 30 microns thick after curing.

31. The method of claim 26, wherein the coating is cured at an energy between about 250 and about 2000 mJ.

32. The method of claim 26, wherein the coating is first cured at an energy between about 70 and about 150 mJ under oxygen atmosphere and is then cured at an energy between about 750 and about 1300 mJ under an inert atmosphere.

33. A coating composition for coating a flexible substrate, said composition comprising at least one acrylic monomer and a polyester acrylate-based oligomer having between 2 and 4 acrylate functionalities.
